(19) United States
(12) Patent Application Publication
(10) Pub. No.: US 2021/0385183 A1
(43) Pub. Date: Dec. 9, 2021

(54) MULTI-FACTOR AUTHENTICATION FOR ACCESSING AN ELECTRONIC MAIL

(71) Applicant: Fortinet, Inc., Sunnyvale, CA (US)

(72) Inventor: Yamidt Gerardo Henao Mota, Mexico City (MX)

(73) Assignee: Fortinet, Inc., Sunnyvale, CA (US)

(21) Appl. No.: 16/894,786

(22) Filed: Jun. 6, 2020

(51) Int. Cl. H04L 12/58; H04L 29/06

(52) U.S. Cl. CPC H04L 51/22; H04L 2463/082; H04L 63/0861; H04L 63/0838

(57) ABSTRACT

Systems and methods for facilitating secure access to email messages based on multi-factor authentication are provided. According to one embodiment, an electronic mail (email) addressed to an email recipient is received by a mail transfer agent (MTA) associated with a mail server. A security policy is assigned to the email by the MTA based on one or both of metadata associated with the email and content of the email. When the security policy calls for multi-factor authentication of the email recipient, the email recipient is caused to be notified regarding existence of the email by the MTA and instructed to complete a multi-factor authentication process in order to access the email. Responsive to successful completion of the multi-factor authentication process, the email is permitted by the MTA to be accessed by the email recipient.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2020, Fortinet, Inc.

### BACKGROUND

### Field

Embodiments of the present invention generally relate to the field of data security and electronic mail communications systems. In particular, embodiments of the present invention relate to systems and methods for limiting access to protected email communications, for example, those designated as containing sensitive information by requiring multi-factor authentication of the recipient before allowing an email to be accessed by the recipient.

### Description of the Related Art

Data security relates to protective digital privacy measures that are applied to prevent unauthorized access to computers, databases and websites. In the context of electronic mail (email), data security is typically provided by requiring users of mail user agents (MUAs) or email clients to authenticate themselves by logging in with a username and a password.

### SUMMARY

Systems and methods are described for facilitating secure access to email messages based on multi-factor authentication. According to one embodiment, an electronic mail (email) addressed to an email recipient is received by a mail transfer agent (MTA) associated with a mail server. A security policy is assigned to the email by the MTA based on one or both of metadata associated with the email and content of the email. When the security policy calls for multi-factor authentication of the email recipient, the email recipient is caused to be notified regarding existence of the email by the MTA and instructed to complete a multi-factor authentication process in order to access the email. Responsive to successful completion of the multi-factor authentication process, the email is permitted by the MTA to be accessed by the email recipient.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIGS. 1A-C conceptually illustrate various network architectures in in accordance with embodiments of the present invention.

FIG. 2 is a block diagram illustrating functional components of a mail server in accordance with an embodiment of the present invention.

FIG. 3 is block diagram illustrating incoming SMTP connections versus outgoing SMTP connections in accordance with an embodiment of the present invention.

FIG. 4 illustrates an example user interface screen for enabling a two factor authentication service in accordance with an embodiment of the present invention.

FIG. 5 illustrates an example user interface screen for configuring a two factor authentication profile in accordance with an embodiment of the present invention.

FIG. 6 illustrates an example user interface screen for adding a two factor authentication content action profile in accordance with an embodiment of the present invention.

FIG. 7 illustrates an example user interface screen for creating a dictionary profile for performing two factor authentication in accordance with an embodiment of the present invention.

FIGS. 8A-B illustrate example user interface screens for configuring content profiles in accordance with an embodiment of the present invention.

FIG. 9A illustrates an example user interface screen for obtaining a local two factor authentication token for performing two factor authentication in accordance with an embodiment of the present invention.

FIG. 9B illustrates an example user interface screen for associating one or more domains with an authentication protocol in accordance with an embodiment of the present invention.

FIG. 10 illustrates an example user interface screen showing an inbound recipient policy and profile in accordance with an embodiment of the present invention.

FIG. 11 illustrates a notification message in accordance with an embodiment of the present invention.

FIG. 12 is a flow diagram illustrating a process for accessing an email in accordance with an embodiment of the present invention.

FIG. 13 illustrates an exemplary computer system in which or with which embodiments of the present invention may be utilized.

### DETAILED DESCRIPTION

Systems and methods are described for facilitating secure access to email messages based on multi-factor authentication. In the following description, numerous specific details are set forth in order to provide a thorough understanding of embodiments of the present invention. It will be apparent to one skilled in the art that embodiments of the present invention may be practiced without some of these specific details.

Existing approaches for protecting access to an email account with a static password that is used to login to an email client is only as secure as the static password. Static passwords represent a vulnerability in that they are easily stolen, guessed and/or obtained, for example, via the use of brute force password-crackers, password stealer malware, and phishing attacks. Meanwhile, it is desirable to implement different levels of security for email messages on an email-by-email basis as some may contain sensitive or confidential information and others may not.

As such, embodiments described herein seek to provide an automated approach for assigning by a mail transfer agent (MTA) or an email security gateway appliance or service (e.g., the FORTIMAIL family of message security products/services available from the assignee of the present invention) operating as an MTA a security policy to an email that defines under what conditions the email is permitted to be accessed. In one embodiment, the MTA may support a multi-factor authentication policy (e.g., a two-factor authentication policy) and one-factor authentication policy. When the two-factor authentication policy is associated with a particular email, access may be restricted to the email until a two-factor authentication process is performed by the email recipient. When the one-factor authentication policy is associated with the particular email, access may be permitted to the email recipient without further authentication (other than having previously provided login credentials)

According to one embodiment, depending upon one or more characteristics (e.g., day/time, content, domain, user group, or connection direction) associated with metadata and/or content of an email, the multi-factor authentication policy or a default policy (e.g., the one-factor authentication policy) may be assigned to the email to control access to the email. As described further below, the characteristics employed may be established by configuring one or more two-factor authentication profiles. Once assigned, the two-factor authentication policy may remain associated with the email even after the email has been read so as to require performance of a two-factor authentication process each time the email at issue is attempted to be read.

Depending upon the particular implementation the second authentication factor may be an authorization token (e.g., a one-time password (OTP) that is valid for a single use or for a defined period of time) that is dynamically generated by a hardware token (e.g., the FORTITOKEN line of hardware token devices available from the assignee of the present invention) or by a software application (e.g., the FORTITOKEN mobile application available from the assignee of the present invention). Alternatively, the second authentication factor may be an authorization code provided to the email recipient, for example, via a short message service (SMS) message sent to a mobile phone or other wireless device of the email recipient. Further still, the second authentication factor may be a dynamic or static biometric authentication factor (e.g., a fingerprint scan, a facial scan, a retina scan, a palm scan, a vein scan, hand geometry, iris recognition, a voice sample, a typing rhythm, and the like).

In some embodiments, one or more two-factor authentication profiles may be used by an MTA separately or in combination (e.g., via their association with another profile or policy as discussed further below) to determine whether to assign a two-factor authentication policy to an email at issue. For example, a first two-factor authentication profile may allow an email administrator of a protected domain to establish one or more dictionary entries in the form of words or phrases, which when found in the content of an email causes a two-factor authentication policy to be assigned to the email. For example, if the body or subject line of the email contains the term (“Confidential,” “Attorneys' Eyes Only,” “Proprietary,”, “Privileged,” or the like), the MTA may assign a two factor authentication policy to the email, requiring the recipient of the email to perform a two factor authentication process before the email may be accessed by the recipient. A second two-factor authentication profile may allow the email administrator to establish times, days, dates, a time range and/or a date range, which when matched by metadata of the email causes the two-factor authentication policy to be assigned to the email. A third two-factor authentication profile may allow the email administrator to establish a user or a user group, which when matched by a sender or a recipient of the email causes the two-factor authentication policy to be assigned to the email. For example, an email recipient may be directed to perform a two-factor authentication process to access emails (i) received from a user within a particular department (e.g., finance, human resources, etc.) or from a user associated with a particular group (e.g., an administrator-defined 2FA group) and/or (ii) directed to a user within a particular department or a user associated with a particular group.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

As used herein, a “network security appliance” or a “network security device” generally refers to a device or appliance in virtual or physical form that is operable to perform one or more security functions. Some network security devices may be implemented as general-purpose computers or servers with appropriate software operable to perform the one or more security functions. Other network security devices may also include custom hardware (e.g., one or more custom Application Specific Integrated Circuits (ASICs)). A network security device is typically associated with a particular network (e.g., a private enterprise network) on behalf of which it provides the one or more security functions. The network security device may reside within the particular network that it is protecting or network security may be provided as a service with the network security device residing in the cloud. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VoIP) support, Virtual Private Networking (VPN), data leak prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), and DoS attack detection appliances (e.g., the FORTIDDOS family of DoS attack detection and mitigation appliances).

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

Systems and methods for facilitating secure access to email messages based on multi-factor authentication are provided. According to one embodiment, a mail transfer agent associated with a mail server receives an electronic mail (email) addressed to an email recipient. The mail transfer agent assigns a security policy to the email based on one or both of metadata associated with the email and content of the email. When the security policy calls for multi-factor authentication of the email recipient, the mail transfer agent causes the email recipient to be notified regarding existence of the email and is instructed to complete a multi-factor authentication process in order to access the email. Upon successful completion of the multi-factor authentication process the mail transfer agent allows the email recipient to access to the email.

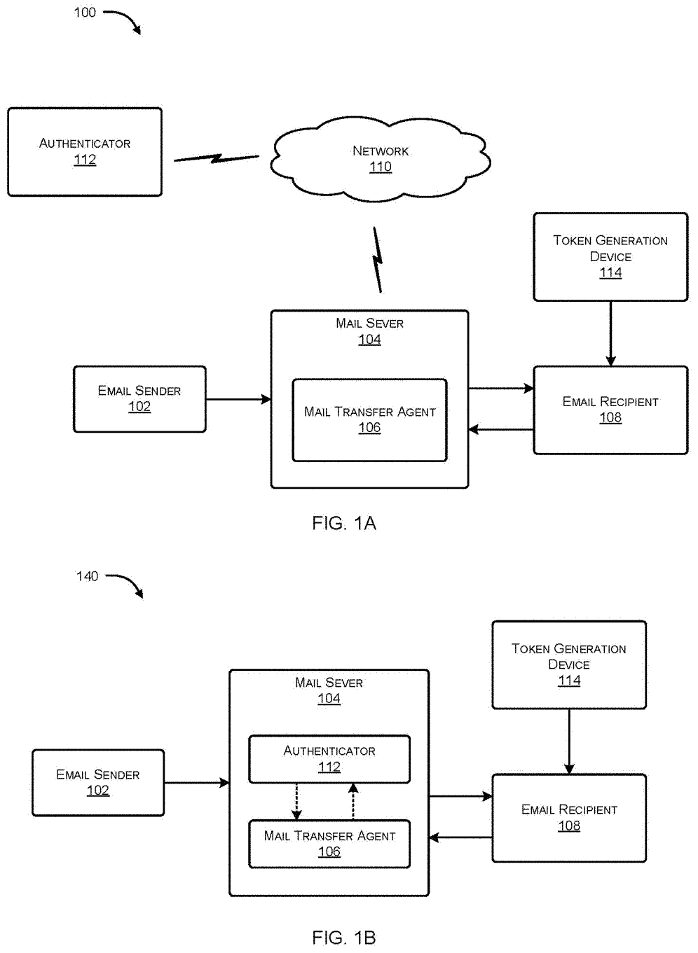

FIGS. 1A-C conceptually illustrate various network architectures in in accordance with embodiments of the present invention. In the context of network architecture 100, a mail transfer agent (MTA) 106 may be associated with a mail server 104. MTA 106 may include an email security gateway running on mail server 104. Alternatively, the email security gateway may be a separate network security device logically interposed between the mail server 104 and email recipients (e.g., email recipient 108) or logically interposed between the mail server 104 and email senders (e.g., email sender 102). For example, the email security gateway may be a physical on-premises network security device, a virtual on-premises, or a cloud-based network security service delivered by a Security-as-a-Service provider, for example, that has integrated their security services into a corporate infrastructure. In one embodiment, MTA 106 may be a Simple Mail Transfer Protocol (SMTP) server that relays email messages to another SMTP server. Also, MTA 106 may be implemented in the form of a software program that facilitates sending and receiving of email.

In these simplified examples, the email sender 102 may send an electronic mail (email) to email recipient 108 and the email may be received by the MTA 106. Depending upon the particular implementation, the content of the email body may be encrypted or may remain in unencrypted form. Responsive to receipt of the email by the MTA 106, the MTA 106 may assign a particular security policy of multiple security policies to the email. The particular security policy may be assigned based on one or both of metadata associated with the email and the content of the email. For example, the two-factor authentication policy may be associated with a particular two-factor authentication profile, which when matched by various characteristics of a received email causes the two-factor authentication policy to be assigned to the received email. For example, assuming the two-factor authentication policy is associated with a content action profile, if the body or subject line of the email contains a term or phrase (e.g., “privileged,” “confidential,” or the like) specified by the content action profile, the MTA 106 may assign the two-factor authentication policy to the email, calling for the email recipient 108 to provide a second factor before the email can be accessed by the email recipient 108.

The MTA 106 may be coupled in communication with an authenticator 112 via a network 110. Those skilled in the art will appreciate that, network 110 can be a wireless network, a wired network or a combination thereof that can be implemented as one of the different types of networks, such as Intranet, Local Area Network (LAN), Wide Area Network (WAN), Internet, and the like. Further, network 110 may be a dedicated network or a shared network, representing an association of different types of networks that use a variety of protocols, for example, Hypertext Transfer Protocol (HTTP), Transmission Control Protocol/Internet Protocol (TCP/IP), Wireless Application Protocol (WAP), and the like

When the assigned security policy calls for multi-factor authentication of email recipient 108, rather than immediately delivering the email to the email recipient 108, the MTA 106 may notify email recipient 108 regarding existence of the email. The notification may instruct the email recipient 108 to complete a multi-factor authentication process in order to access the email. Depending upon the particular implementation, the multi-factor authenticator process may be performed by mail server 104 (see, e.g., FIG. 1B), by an authentication service running on authenticator 112 connected to MTA 106 via network 110 or by a multi-factor authenticator cloud service.

In network architecture 140, authenticator 112 may be present within mail server 104 and may communicate with MTA 106. As part of the multi-factor authenticator process, MTA 106 may receive a value of a second authentication factor (with may also be referred to simply as a second factor) from the email recipient 108. Those skilled in the art will appreciate, there are three general categories of factors that may be used for user authentication (something you know (e.g., a password), something you have (e.g., a smart card or token), and something you are (e.g., a fingerprint or other biometric method)). According to one embodiment, the second authentication factor may represent an OTP, a biometric authentication factor (e.g., a fingerprint scan, a facial scan, a retina scan, a palm scan, a vein scan, hand geometry, iris recognition, a voice sample, a typing rhythm, or the like) or an authentication code. For example, in the context of the present example, a token generation device 114 is shown being used by the email recipient 108. The token generation device 114 may periodically dynamically generate OTPs or dynamically generate an OTP responsive to a request from the email recipient 108. The OTP(s) generated by the token generator may be valid for a single use or for a defined period of time.

In one embodiment, as part of the multi-factor authentication process, an authentication code may be sent to the email recipient 108 by or on behalf of the MTA 106 via an out-of-band channel (e.g., via a short message service (SMS) text message directed to a mobile device, such as a smartphone, of the email recipient 108). In other embodiments, a two-factor authentication app running, for example, on the smartphone of the email recipient 108 may enable the smartphone itself to server as the physical device to satisfy the possession factor.

To complete the multi-factor authentication process, the second authentication factor may be provided by or on behalf of the email recipient 108 to the entity or service performing the authentication. For example, in a scenario in which the second authentication factor is an authentication code, the email recipient 108 may manually input the authentication code into a form (e.g., a Hypertext Markup Language (HTML) form) presented to the email recipient 108 by or on behalf of the authenticator 112. Upon receiving the value of the second authentication factor, the authentication may be performed by mail server 104, by an authentication service running on authenticator 112 or by a multi-factor authenticator cloud service. The multi-factor authentication process may be determined to be successfully completed when the value of the second authentication factor matches a correct value of the second authentication factor. Subsequently, upon successful completion of the multi-factor authentication process, the MTA 106 may allow the email to be accessed by email recipient 108.

In network architecture 180, at step 1, when the security policy calls for multi-factor authentication of the email recipient 108, the MTA 106 may send a notification regarding existence of the email, instructing the email recipient 108 to perform a multi-factor authentication process in order to access the email. At step 2, MTA 106 may receive a value of a second authentication factor (e.g., an OTP, a biometric authentication factor, an authentication code or the like) from email recipient 108 for validation. When the value of the second authentication factor matches a correct value of the second authentication factor, MTA 106 may determine the multi-factor authentication process has been successfully completed. In response to successful completion of the multi-factor authentication process, at step 3 MTA 106 may allow the email to be accessed by the email recipient 108.

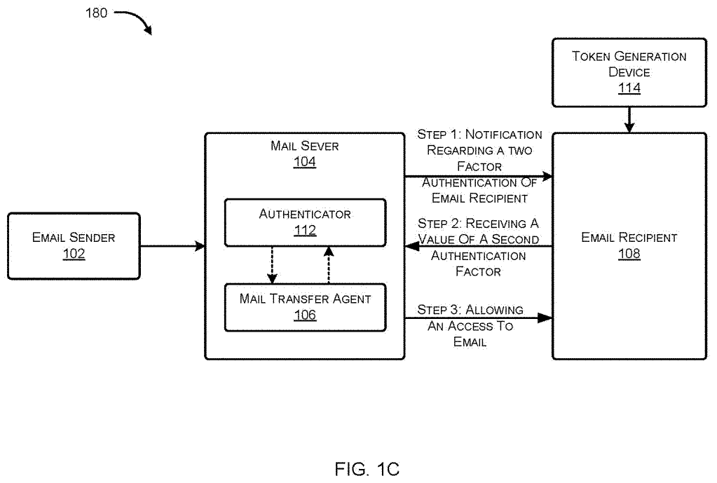

FIG. 2 is a block diagram 200 illustrating functional components of a mail server in accordance with an embodiment of the present invention. In context of the present diagram, mail server 104 can include one or more processing resources (e.g., processor(s) 202). Processor(s) 202 can be implemented as one or more microprocessors, microcomputers, microcontrollers, digital signal processors, central processing units, logic circuitries, and/or any devices that manipulate data based on operational instructions. Among other capabilities, processor(s) 202 are configured to fetch and execute computer-readable instructions stored in a memory 204 of mail server 104. Memory 204 can store one or more computer-readable instructions or routines, which may be fetched and executed to create or share the data units over a network service. Memory 204 can include any non-transitory storage device including, for example, volatile memory such as RAM, or non-volatile memory such as EPROM, flash memory, and the like. In an example embodiment, memory 204 may be a local memory or may be located remotely, such as a server, a file server, a data server, and the Cloud.

Mail server 104 can also include one or more interface(s) 206. Interface(s) 206 may include a variety of interfaces, for example, interfaces for data input and output devices, referred to as I/O devices, storage devices, and the like. Interface(s) 206 may facilitate communication of mail server 104 with various devices coupled to mail server 104. Interface(s) 206 may also provide a communication pathway for one or more components of mail server 104. Examples of such components include, but are not limited to, processing engine(s) 208 and database 210.

Processing engine(s) 208 can be implemented as a combination of hardware and software or firmware programming (for example, programmable instructions) to implement one or more functionalities of engine(s) 208. In the examples described herein, such combinations of hardware and software or firmware programming may be implemented in several different ways. For example, the programming for the engine(s) 208 may be processor executable instructions stored on a non-transitory machine-readable storage medium and the hardware for engine(s) 208 may include a processing resource (for example, one or more processors), to execute such instructions. In the examples, the machine-readable storage medium may store instructions that, when executed by the processing resource, implement engine(s) 208. In such examples, mail server 104 can include the machine-readable storage medium storing the instructions and the processing resource to execute the instructions, or the machine-readable storage medium may be separate but accessible to mail server 104 and the processing resource. In other examples, processing engine(s) 208 may be implemented by electronic circuitry. Database 210 can include data that is either stored or generated as a result of functionalities implemented by any of the components of processing engine(s) 208.

In an example, processing engine(s) 208 can include an electronic mail receiving engine 212, a security policy assigning engine 214, a multi-factor authentication engine 216, an electronic mail accessing engine 218, and other engine(s) 220. Other engine(s) 220 can implement functionalities that supplement applications or functions performed by mail server 104 or processing engine(s) 208.

According to an embodiment, electronic mail receiving engine 212 is responsible for receiving emails addressed to email recipients (e.g., email recipient 108) within one or more protected domains. The emails received may be in unencrypted (e.g., plain text) or an encrypted form. In the context of the present example, responsive to receipt of an email, the mail receiving engine 212 causes the security policy assigning engine 214 to assign a security policy of multiple security policies to the email. In one embodiment, the security policy is assigned based on one or both of metadata associated with the email and content of the email. When the security policy calls for multi-factor authentication (e.g., two-factor authentication) of the email recipient, multi-factor authentication engine 216 is responsible for causing the email recipient to be notified regarding the existence of the email and instructing the email recipient to perform a multi-factor authentication process in order to access the email.

As those skilled in the art appreciate, there are a number of ways to implement multi-factor authentication. In one embodiment, a multi-factor authentication process includes receiving a value of a second authentication factor from the email recipient and validating same. As noted above, the second authentication factor may represent an OTP, a biometric authentication factor, or an authentication code. For example, an authentication code may be sent to the email recipient via a short message service (SMS) to a mobile phone of the email recipient to confirm the identity of the email recipient by way of his/her possession of the mobile phone.

The multi-factor authentication process may be performed by or on behalf of a mail server, for example, by an authentication service running on an authenticator or a multi-factor authenticator cloud service. Successful completion of the multi-factor authentication process may be determined when the value of the second authentication factor matches the correct value of the second authentication factor (e.g., the supplied authentication code). Upon successful completion of the multi-factor authentication process, electronic mail accessing engine 218 allows the email recipient to access the email.

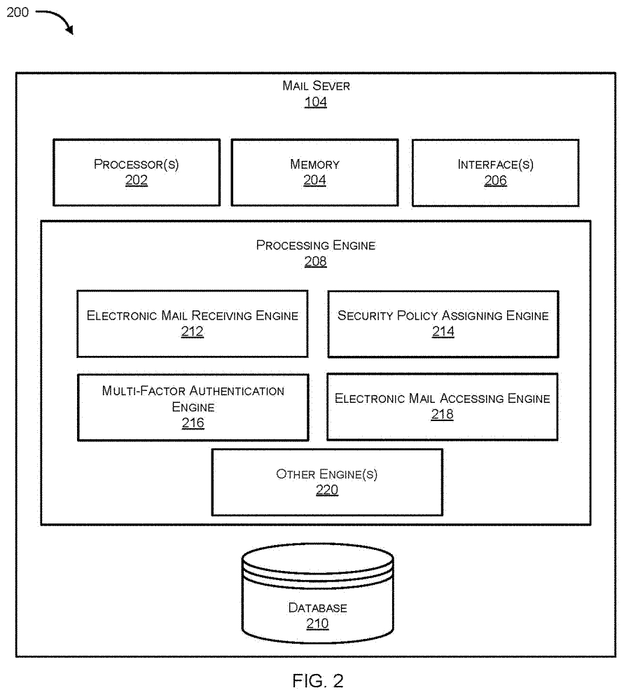

FIG. 3 is block diagram 300 illustrating incoming SMTP connections versus outgoing SMTP connections in accordance with an embodiment of the present invention. In the context of the present example, at 300, the assignment of a security policy to a received email may be established based at least in part on the direction of an SMTP connection or the email message. For example, rather than being based upon the origin of the SMTP connection or email message, incoming or outgoing directionality may be determined based on whether a destination of the email is within a protected domain.

In one embodiment, incoming connections refer to SMTP connections that are destined for SMTP servers within one or more protected domains protected by an email security gateway. For example, at 304, if the email security gateway is configured to protect the SMTP server having an IP address of X.X.X.X, the email security gateway may treat all SMTP connections to X.X.X.X as incoming connections, regardless of their origin.

Outgoing connections may refer to SMTP connections that are destined for SMTP servers that the email security gateway has not been configured to protect. For example, at 302, if the email security gateway is not configured to protect the SMTP server having an IP address of Y.Y.Y.Y, then, SMTP connections to Y.Y.Y.Y may be treated as outgoing connections, regardless of their origin.

In the context of the present example, emails or SMTP connections to internal mail relay 304 from any of external MTAs 302, internal mail server 306, or remote MUA are considered incoming connections, whereas emails or SMTP connections to external MTAs 302 or internal mail server 306 from internal mail relay 304 are considered outgoing connections.

In an implementation, the email security gateway may receive emails for a set of defined email domains and may control relay of the emails to other domains. Email passing through the email security gateway may be scanned, for example, to detect the presence of viruses and/or spam based on established policies and profiles. Additionally, actions may be determined for the emails containing viruses or spam. Further, a profile menu may be used to configure multiple profile types that include a collection of settings for identifying anti-spam, antivirus, whether to perform additional authentication (e.g., two-factor authentication), or other features associated with email processing. The configured profile type may be applied either directly in a policy, or indirectly by inclusion in another profile that is selected in a policy. Those skilled in the art will appreciate that policies may apply to each of a selected profile of all emails and SMTP connections that the policy governs.

Further, creating multiple profiles for each type of the policy may facilitate to customize an email service by applying different profiles to policies that govern different SMTP connections or email users. For instance, an Internet service provider (ISP) may want to create and apply antivirus profiles to policies governing email users that provide reimbursements to receive antivirus protection. In addition to policies and profiles, other configured items e.g., email domains may affect how the email security gateway processes an email.

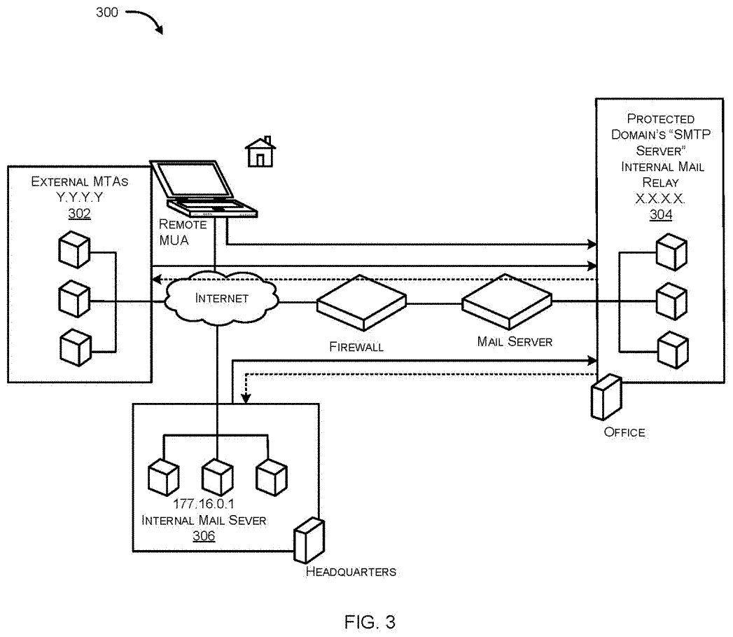

FIG. 4 illustrates an example user interface screen 400 for enabling a two factor authentication service in accordance with an embodiment of the present invention. In the context of the present example, a security policy in form of a two factor authentication service may be enabled and various notification settings may be configured. In one embodiment, enabling of the two factor authentication service allows selective assignment of a two-factor authentication policy directly or indirectly via one or more two-factor authentication profiles to received emails having certain characteristics (e.g., based on time/date, content, domain, user group, etc.) associated with metadata and/or content of the received emails. In various embodiments described herein, when a two-factor authentication policy has been assigned to an email, the email recipient may be prompted to perform a two-factor authentication process before being provided access to the email. Depending upon the particular implementation, the two-factor authentication process may involve an authorization service or authorization appliance acting on behalf of the MTA to receive a correct value of a second authentication factor, for example, in the form of an authorization token (e.g., a one-time password (OTP) that is valid for a single use or for a defined period of time) and that is dynamically generated by a hardware token.

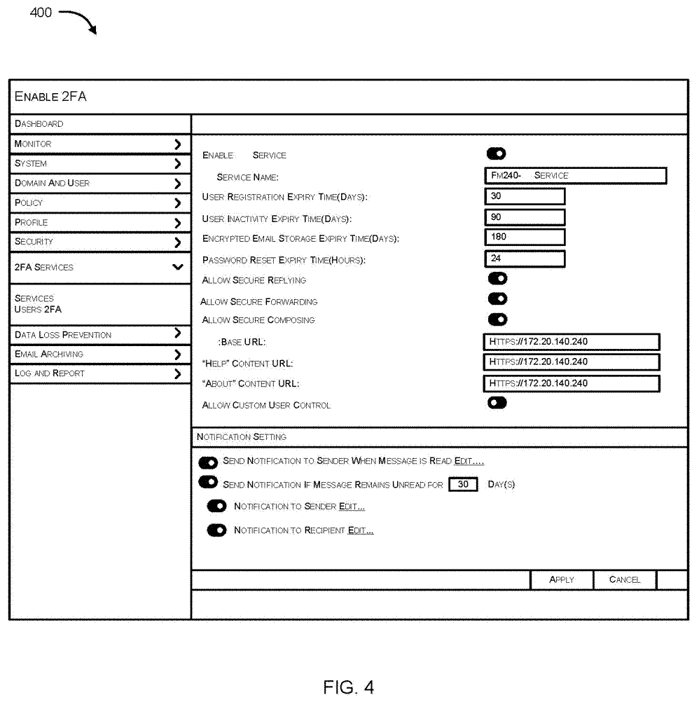

FIG. 5 illustrates an example user interface screen 500 for configuring a two factor authentication profile in accordance with an embodiment of the present invention. In the context of the present example, the two-factor authentication profile is based on a user group. In the context of the present example, the-two factor authentication profile is configured by providing a descriptive name for the two-factor authentication profile, the protocol (e.g., a local or remote authenticator or authentication service) to be used, which may be selected from a drop-down list, an access method, a user group, and a corresponding action.

As those skilled in the art will appreciate, a user group is merely one example of a characteristic of meta data and/or content of an email that may be used to identify an appropriate security policy (e.g., a two-factor authentication policy) to an email. Other non-limiting examples include day/time, content, domain, and connection direction (e.g., incoming connection or outgoing connection).

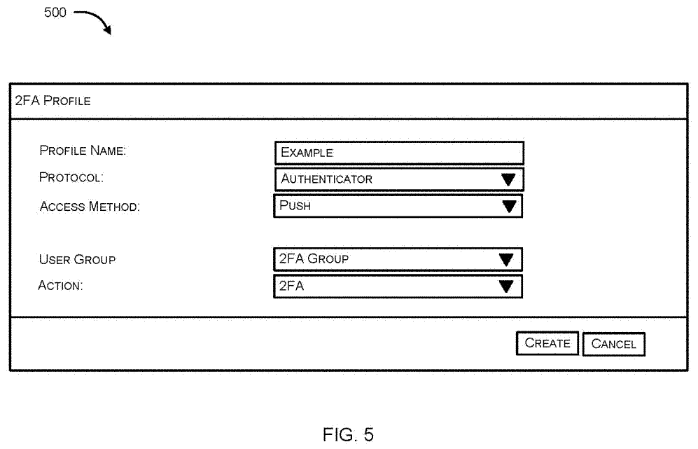

FIG. 6 illustrates an example user interface screen 600 for adding a two factor authentication content action profile in accordance with an embodiment of the present invention. In context of the present example, a particular two-factor authentication profile may be further refined with additional actions and/or processing to be applied to emails matching the particular two-factor authentication profile. For example, the content action profile may, among other things, cause the email's subject line to be tagged with a specified value, a new header fields may be inserted with a specified value, an existing notification profiles may be assigned or a new notification profile may be created, and a final action (e.g., the two-factor authentication profile) may be selected. Finally a create button may be used to create and save the content action profile.

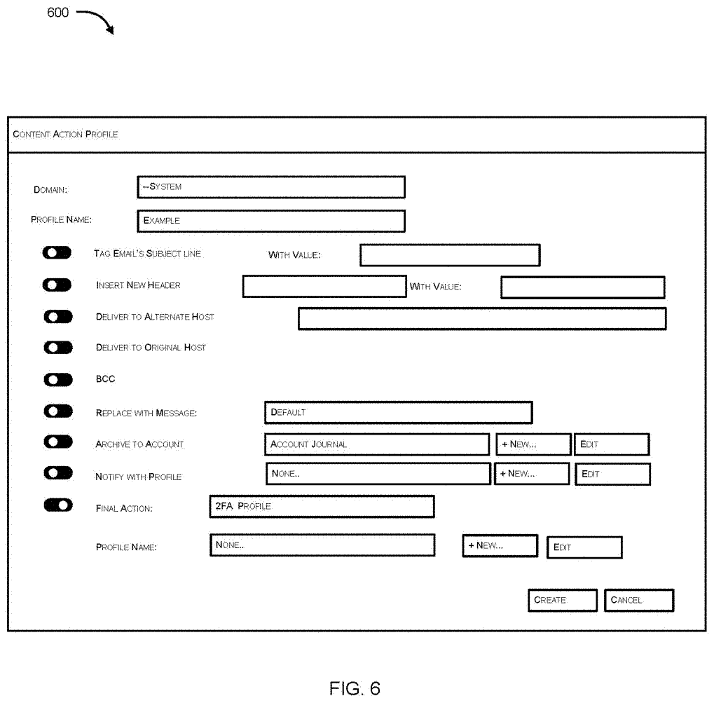

FIG. 7 illustrates an example user interface screen 700 for creating a dictionary profile for performing two factor authentication in accordance with an embodiment of the present invention. In the context of the present example, various pre-defined patterns (e.g., indicative of a credit card number, a social security number (SSN), a bank account number, a routing number, or the like) may be selectively enabled or disabled for various scan areas (e.g., the header and/or body) of an email. Additionally, new dictionary entries may be created, labeled with a descriptive name, and selectively enabled or disabled. For example, various key words or phrases may be specified that will trigger a two-factor authentication policy or action associated with the content action profile. Non-limiting examples of key words that might be used as dictionary entries, as they are indicative of a desire on the part of the sender for access to the email to be protected by two-factor authentication, include “Confidential,” “Attorney Eyes' Only,” “Proprietary,” “Privileged,” and the like. In the context of the present example, the email administrator has flexibility to specify any key words or phrases as dictionary entries or may use no dictionary entries.

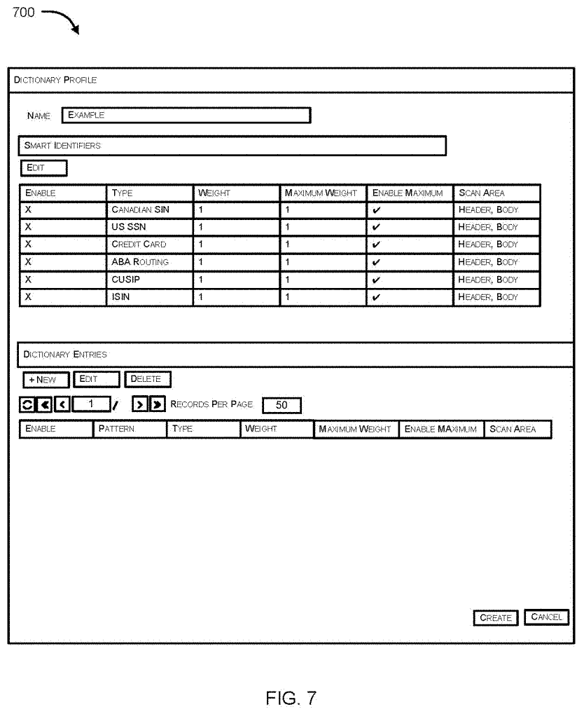

FIGS. 8A-B illustrate user interface screens 800 and 850 for configuring content profiles in accordance with an embodiment of the present invention. In the context of the present example, a content monitor and filtering section of user interface screen 800 may be used to configure a content profile. Further, user interface screen 850 may be used to select a dictionary containing the desired dictionary entries from a dictionary profile selection dropdown list. Additionally, a minimum score (e.g., number matches to dictionary entries) may be defined before a selected action is triggered. In some embodiments, content of various types of email attachments may also be selectively enabled/disabled for content scanning.

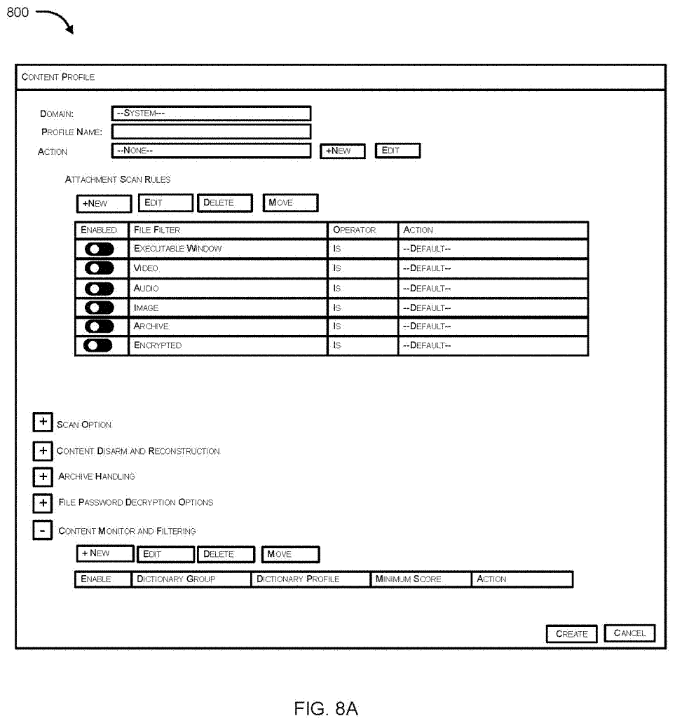

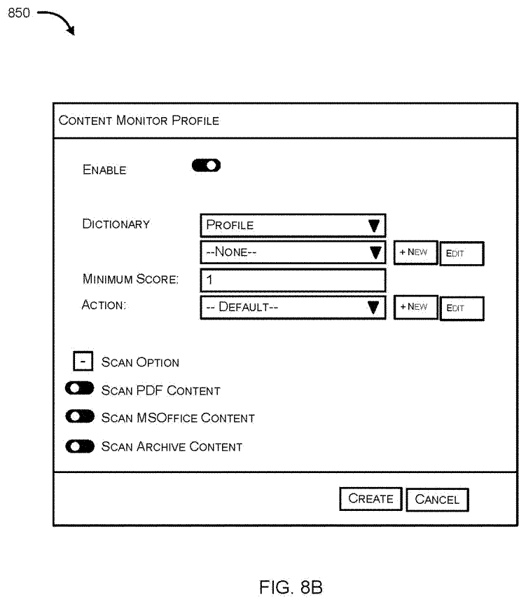

FIG. 9A illustrates an example user interface screen 900 for associating users with authentication protocols in accordance with an embodiment of the present invention. According to one embodiment, users of an enterprise may be added and selectively enabled/disabled as active two-factor authentication users via user interface screen 900 by identifying the users by their email address and/or name. For example, users that have been provided with a token generation device or have installed a token generation app on their mobile phone may be enabled as active two-factor authentication users.

FIG. 9B illustrates an example user interface screen 950 for associating one or more domains with an authentication protocol in accordance with an embodiment of the present invention. According to one embodiment, a particular authentication protocol (e.g., a local or cloud-based authentication service) may be established for all email users associated with one or more domains matching one or more domain patterns (e.g., specified by the email administrator in in the form of a regular expression or the like).

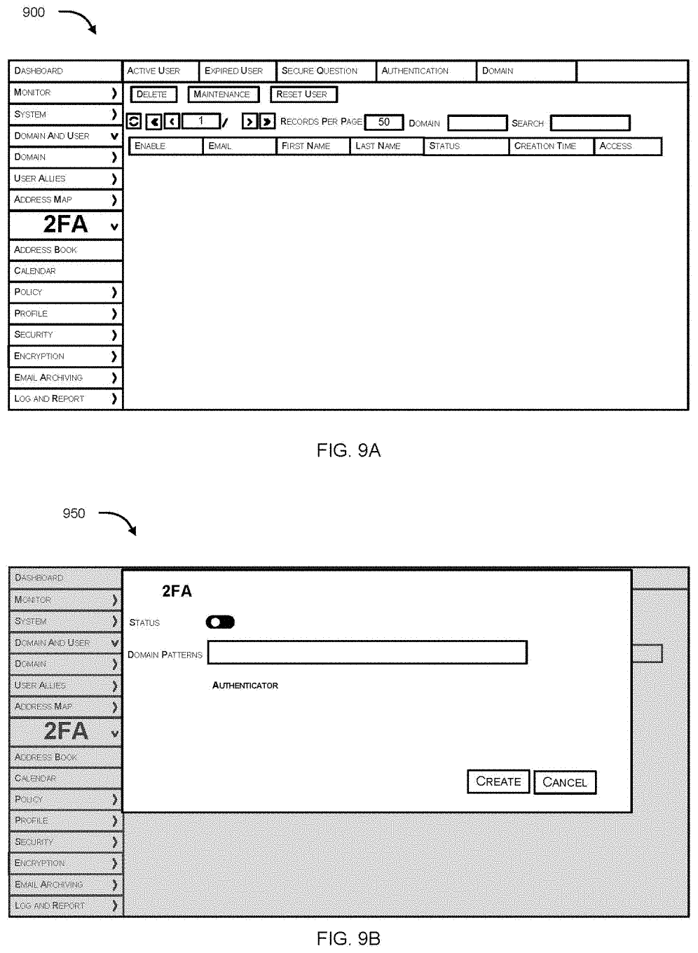

FIG. 10 illustrates an example user interface screen 1000 showing an inbound recipient policy and profile in accordance with an embodiment of the present invention. In the context of the present example, a policy for an email may be set based on a sender pattern and/or a recipient pattern based on a direction of the connection (e.g., an incoming connection or an outgoing connection) and adding an appropriate existing two factor authentication profile. In an implementation, depending upon the emails to which the two factor authentication policy is to be applied, IP-based or recipient-based policies may be used. For example, if an email administrator wants to apply two-factor authentication to all inbound email for all users of an enterprise, the email administrator can create a sender-based policy with “*.example.com” as the sender or recipient.

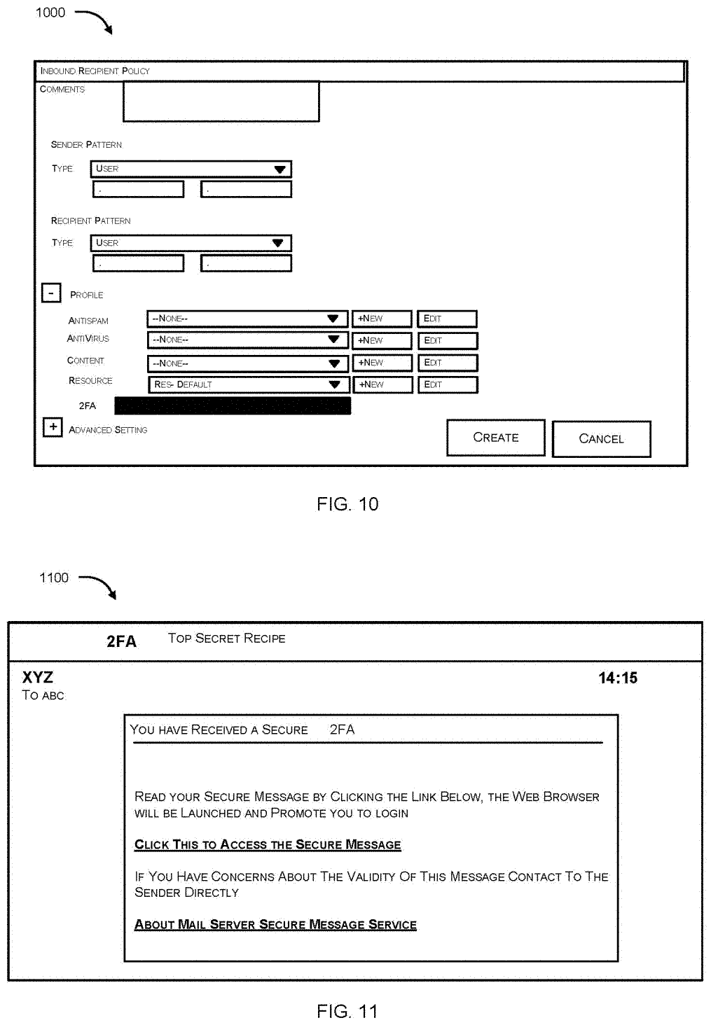

FIG. 11 illustrates a notification message 1100 in accordance with an embodiment of the present invention. In the context of the present example, the notification message 1100 notifies an email recipient (e.g., email recipient 108) regarding receipt of a secure two factor authentication pull message by a mail server (e.g., mail server 104) that is directed to the email recipient. In one embodiment, the notification message 1100 includes a hyperlink that may be selected by the email recipient to access the secure message. Responsive to selection of the hyperlink, a browser page may be opened that displays an HTML form, prompting the email recipient to input the second authentication factor (e.g., an authentication token generated by the email recipient's token generator or an authorization code sent via text message to the email recipient) within an input field on the form. When the second authentication token provided by the email recipient matches that expected by an authorization service used by the mail server or an email security device associated therewith, the secure message may be made available for access by the email recipient. In one embodiment, after the secured email is closed, a subsequent access of the secured email may again prompt the email recipient to perform the two-factor authentication process.

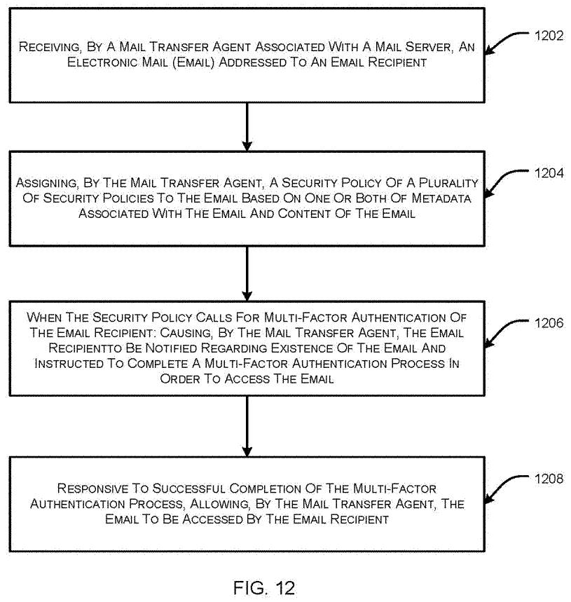

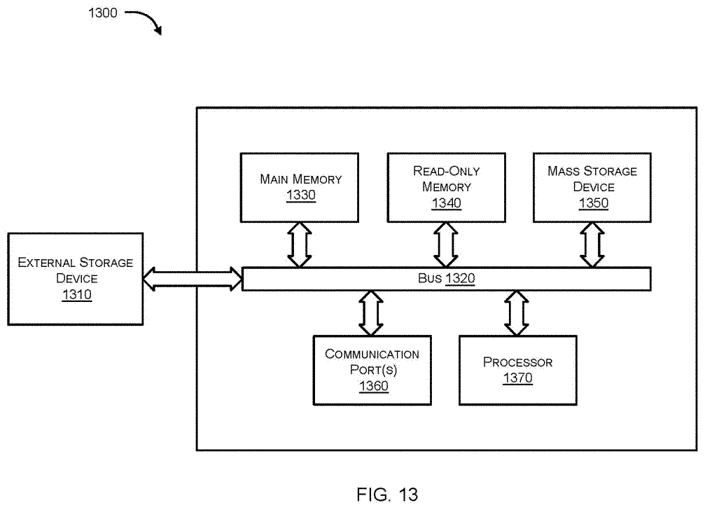

FIG. 12 is a flow diagram illustrating MTA processing in accordance with an embodiment of the present invention. The processing described with reference to FIG. 12 may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, this processing may be performed by one or more computer systems of various forms, such as the computer system 1300 described below with reference to FIG. 13 below.

In the context of the present example, at block 1202, an MTA associated with a mail server receives an electronic mail (email) addressed to an email recipient. According to one embodiment, the MTA may be represented by an email security gateway appliance or service running in MTA mode and coupled in communication with the mail server. Alternatively, the MTA (e.g., MTA 106) may be an internal process running on the mail server (e.g., mail server 104).

At block 1204, a security policy of multiple security policies is assigned by the MTA to the email based on one or both of metadata associated with the email and content of the email. According to one embodiment, depending upon one or more characteristics (e.g., day/time, content, domain, user group, or connection direction) associated with the metadata and/or the content (e.g., body, header, and/or attachments) of an email, a multi-factor authentication policy or a default policy (e.g., a one-factor authentication policy) may be assigned to the email to control access to the email. As described herein, the characteristics employed may be determined based on the configuration of one or more types of profiles (e.g., a user or user-group-based two-factor authentication profile, a content action profile, a content profile, a dictionary profile, etc.) used in connection with the email at issue.

At block 1206, when the security policy calls for multi-factor authentication of the email recipient, the MTA causes the email recipient to be notified regarding existence of the email and is instructed to complete a multi-factor authentication process in order to access the email. According to one embodiment, the notification may be in the form of a notification message (e.g., notification message 1100) that prompts the email recipient to select a link within the notification message to access the secure message. Responsive to selection of the link, a separate browser page may be opened within a web browser running on a client device being used by the email recipient that displays an HTML form. The HTML form may prompt the email recipient to input a second authentication factor (e.g., an authentication token generated by the email recipient's token generator or an authorization code sent via text message to the email recipient) within an input field on the form.

At block 1208, responsive to successful completion of the multi-factor authentication process, the MTA allows the email to be accessed by the email recipient. For example, the secured email may be delivered by the MTA to the MUA being used by the email recipient for display to the client via the MUA.

FIG. 13 illustrates an exemplary computer system 1300 in which or with which embodiments of the present invention may be utilized. As shown in FIG. 13, computer system includes an external storage device 1310, a bus 1320, a main memory 1330, a read only memory 1340, a mass storage device 1350, a communication port 1360, and a processor 1370. In one embodiment, computer system 1300 may represent some portion of a mail server (e.g., mail server 104 of FIGS. 1A, B, and C), an email security gateway appliance or a cloud-based computing environment providing an email security gateway service.

Those skilled in the art will appreciate that computer system 1300 may include more than one processor 1370 and communication ports 1360. Examples of processor 1370 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 1370 may include various modules associated with embodiments of the present invention.

Communication port 1360 can be any of an RS-232 port for use with a modem based dialup connection, a 10/100 Ethernet port, a Gigabit or 10 Gigabit port using copper or fiber, a serial port, a parallel port, or other existing or future ports. Communication port 1360 may be chosen depending on a network, such a Local Area Network (LAN), Wide Area Network (WAN), or any network to which computer system connects.

Memory 1330 can be Random Access Memory (RAM), or any other dynamic storage device commonly known in the art. Read only memory 1340 can be any static storage device(s) e.g., but not limited to, a Programmable Read Only Memory (PROM) chips for storing static information e.g. start-up or BIOS instructions for processor 1370.

Mass storage 1350 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 1320 communicatively couples processor(s) 1370 with the other memory, storage and communication blocks. Bus 1320 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 1370 to software system.

Optionally, operator and administrative interfaces, e.g. a display, keyboard, and a cursor control device, may also be coupled to bus 1320 to support direct operator interaction with computer system. Other operator and administrative interfaces can be provided through network connections connected through communication port 1360. External storage device 1310 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

What is claimed is:

1. A method comprising:
receiving, by a mail transfer agent associated with a mail server, an electronic mail (email) addressed to an email recipient;
assigning, by the mail transfer agent, a security policy of a plurality of security policies to the email based on one or both of metadata associated with the email and content of the email; and
when the security policy calls for multi-factor authentication of the email recipient:
causing, by the mail transfer agent, the email recipient to be notified regarding existence of the email and instructed to complete a multi-factor authentication process in order to access the email; and
responsive to successful completion of the multi-factor authentication process, allowing, by the mail transfer agent, the email to be accessed by the email recipient.

2. The method of claim 1, wherein the mail transfer agent comprises an email security gateway.

3. The method of claim 2, wherein the email security gateway comprises a process running on the mail server.

4. The method of claim 2, wherein the email security gateway is delivered in a form of a service by as a Security-as-a-Service provider.

5. The method of claim 1, wherein the multi-factor authentication process comprises:
receiving, by the mail transfer agent, a value of a second authentication factor from the email recipient; and
determining, by the mail transfer agent, the successful completion of the multi-factor authentication process when the value of the second authentication factor matches a correct value of the second authentication factor.

6. The method of claim 5, wherein the second authentication factor represents a one-time password (OTP).

7. The method of claim 5, wherein the second authentication factor represents a biometric authentication factor.

8. The method of claim 5, wherein the second authentication factor represents an authentication code and wherein the method further comprises causing, by the mail transfer agent, the correct value to be sent to the email recipient via a short message service (SMS) directed to a mobile phone of the email recipient.

9. A non-transitory computer-readable storage medium embodying a set of instructions, which when executed by a processing resource of a mail transfer agent (MTA) causes the processing resource to perform a method comprising:
receiving an electronic mail (email) addressed to an email recipient;
assigning a security policy of a plurality of security policies to the email based on one or both of metadata associated with the email and content of the email; and
when the security policy calls for multi-factor authentication of the email recipient:
causing the email recipient to be notified regarding existence of the email and instructed to complete a multi-factor authentication process in order to access the email; and
responsive to successful completion of the multi-factor authentication process, allowing the email to be accessed by the email recipient.

10. The non-transitory computer-readable storage medium of claim 9, wherein the mail transfer agent comprises an email security gateway.

11. The non-transitory computer-readable storage medium of claim 10, wherein the email security gateway comprises a process running on the mail server.

12. The non-transitory computer-readable storage medium of claim 10, wherein the email security gateway is delivered in a form of a service by as a Security-as-a-Service provider.

13. The non-transitory computer-readable storage medium of claim 9, wherein the multi-factor authentication process comprises:
receiving a value of a second authentication factor from the email recipient; and
determining the successful completion of the multi-factor authentication process when the value of the second authentication factor matches a correct value of the second authentication factor.

14. The non-transitory computer-readable storage medium of claim 13, wherein the second authentication factor represents a one-time password (OTP).

15. The non-transitory computer-readable storage medium of claim 13, wherein the second authentication factor represents an authentication code and wherein the method further comprises causing the correct value to be sent to the email recipient via a short message service (SMS) directed to a mobile phone of the email recipient.

16. A system comprising:
a processing resource; and
a non-transitory computer-readable medium, coupled to the processing resource, having stored therein instructions that when executed by the processing resource cause the processing resource to perform a method comprising:
receiving an electronic mail (email) addressed to an email recipient;
assigning a security policy of a plurality of security policies to the email based on one or both of metadata associated with the email and content of the email; and
when the security policy calls for multi-factor authentication of the email recipient:
causing the email recipient to be notified regarding existence of the email and instructed to complete a multi-factor authentication process in order to access the email; and
responsive to successful completion of the multi-factor authentication process, allowing the email to be accessed by the email recipient.

17. The system of claim 16, wherein the system comprises a network security device coupled in communication with a mail server.

18. The system of claim 16, wherein the second authentication factor represents a one-time password (OTP).

19. The system of claim 16, wherein the second authentication factor represents an authentication code and wherein the method further comprises causing the correct value to be sent to the email recipient via a short message service (SMS) directed to a mobile phone of the email recipient.

20. The system of claim 16, wherein at least some portion of the content is encrypted.
